(19) United States
(12) Patent Application Publication
(10) Pub. No.: US 2026/0010143 A1
(43) Pub. Date: Jan. 8, 2026

(54) HIGH ASPECT RATIO CARBON ETCH WITH SIMULATED BOSCH PROCESS

(71) Applicant: Lam Research Corporation, Fremont, CA (US)

(72) Inventors: Zhongkui TAN, Fremont, CA (US); Jing LI, Milpitas, CA (US); Xiaofeng SU, Fremont, CA (US); Priyadarsini SUBRAMANIAN, Milpitas, CA (US); Gowri Channa KAMARTHY, Pleasanton, CA (US)

(21) Appl. No.: 18/881,198

(22) PCT Filed: Jul. 20, 2023
(86) PCT No.: PCT/US2023/028263

§ 371 Date: Jan. 3, 2025

Related U.S. Application Data
(60) Provisional application No. 63/369,147, filed on Jul. 22, 2022.

(51) Int. Cl. G05B 19/4099

(52) U.S. Cl. CPC G05B 19/4099; G05B 2219/45031

(57) ABSTRACT

Various embodiments herein relate to methods and apparatus for etching a substrate. The substrate is typically a semi-conductor substrate. In various implementations, the method involves receiving the substrate in a process chamber, the substrate including a carbon layer and a mask layer positioned over the carbon layer, where the mask layer is patterned to define where the feature will be etched in the carbon layer; and exposing the substrate to a plasma to etch the feature into the carbon layer of the substrate, wherein a composition of the plasma changes over time to provide at least a deposition step, a clear step, and an etch step, and wherein the deposition step, the clear step, and the etch step are cycled with one another until the feature reaches its final depth.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in their entireties and for all purposes.

### BACKGROUND

One process that may be employed during fabrication of semiconductor devices is formation of recessed features in dielectric material. Such features may be formed through etching, using a patterned mask layer that defines where the features are to be etched in the dielectric material. One material that may be used for this mask layer is carbon. Example contexts where such processes may occur include, but are not limited to, memory applications such as DRAM and 3D NAND structures.

As the semiconductor industry advances and device dimensions become smaller, these recessed features become increasingly difficult to etch.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In one aspect of the disclosed embodiments, a method of etching a feature into a substrate is provided, the method including: receiving the substrate in a process chamber, the substrate including a carbon layer and a mask layer positioned over the carbon layer, where the mask layer is patterned to define where the feature will be etched in the carbon layer; and exposing the substrate to a plasma to etch the feature into the substrate, where a composition of the plasma changes over time to provide at least a deposition step, a clear step, and an etch step, and where the deposition step, the clear step, and the etch step are cycled with one another until the feature reaches its final depth.

In various embodiments, during the deposition step the plasma may be generated from a first plasma generation gas including an first oxygen source and a boron source, and exposing the substrate to the plasma during the deposition step results in forming boron oxide on sidewalls of the feature. In some embodiments, during the clear step the plasma may be generated from a second plasma generation gas including a second oxygen source and a halogen source, and exposing the substrate to the plasma during the clear step may result in removing boron oxide proximate an etch front within the feature. In some embodiments, during the etch step the plasma is generated from a third plasma generation gas including a third oxygen source, and exposing the substrate to the plasma during the etch step results in etching the feature isotropically at the etch front within the feature.

In various embodiments, the deposition step, the clear step, and the etch step may be cycled with one another in iterations, and the deposition step, the clear step, and the etch step may be balanced against one another differently in different iterations. In some such embodiments, balancing the deposition step, the clear step, and the etch step against one another differently in different iterations may result in an etch profile including at least a first portion and a second portion, the first portion and second portion having different profile shapes selected from vertical, reentrant, or tapered. In some embodiments, during a first iteration, the deposition step, the clear step, and the etch step may be balanced against one another at a first balance, and during a second iteration, the deposition step, the clear step, and the etch step may be balanced against one another at a second balance, where the second iteration occurs after the first iteration, and where the second balance favors the deposition step over the etch step to a greater degree than the first balance, such that an etch profile that forms at an etch front within the feature during the second iteration has a shape that is tapered. In some embodiments, during a first iteration, the deposition step, the clear step, and the etch step may be balanced against one another at a first balance, and during a second iteration, the deposition step, the clear step, and the etch step may be balanced against one another at a second balance, where the second iteration occurs after the first iteration, and where the second balance favors the etch step over the deposition step to a greater degree than the first balance, such that an etch profile that forms at an etch front within the feature during the second iteration has a shape that is reentrant.

In various embodiments, the plasma is generated in a continuous manner such that it is not extinguished between the deposition step, the clear step, and the etch step. The clear step may occur immediately after either the deposition step or the etch step in various embodiments.

In another aspect of the disclosed embodiments, an apparatus for etching a feature into a substrate is provided, the apparatus including: a process chamber; a substrate holder positioned in the process chamber, where the substrate holder is configured to support the substrate, the substrate including a carbon layer and a mask layer positioned over the carbon layer, where the mask layer is patterned to define where the feature will be etched in the carbon layer; an inlet to the process chamber configured to provide reactants to the process chamber; an outlet to the process chamber configured to remove materials from the process chamber; a plasma generator configured to generate plasma in the process chamber; and a controller configured to cause: exposing the substrate to a plasma to etch the feature into the substrate, where a composition of the plasma changes over time to provide at least a deposition step, a clear step, and an etch step, and where the deposition step, the clear step, and the etch step are cycled with one another until the feature reaches its final depth.

In various embodiments, during the deposition step, the controller may be configured to cause generating the plasma from a first plasma generation gas including an first oxygen source and a boron source such that exposing the substrate to the plasma during the deposition step results in forming boron oxide on sidewalls of the feature. In some embodiments, during the clear step, the controller may be configured to cause generating the plasma from a second plasma generation gas including a second oxygen source and a halogen source such that exposing the substrate to the plasma during the clear step results in removing boron oxide proximate an etch front within the feature. In some embodiments, during the etch step, the controller may be configured to cause generating the plasma from a third plasma generation gas including a third oxygen source such that exposing the substrate to the plasma during the etch step results in etching the feature isotropically at the etch front within the feature.

In various embodiments, the controller may be configured to cause the deposition step, the clear step, and the etch step to be cycled with one another in iterations, and the controller may be configured to cause the deposition step, the clear step, and the etch step to be balanced against one another differently in different iterations. In some embodiments, the controller may be configured to cause balancing the deposition step, the clear step, and the etch step against one another differently in different iterations such that an etch profile including at least a first portion and a second portion forms within the feature, the first portion and second portion having different profile shapes selected from vertical, reentrant, or tapered. In some embodiments, the controller may be configured to cause balancing the deposition step, the clear step, and the etch step against one another at a first balance during a first iteration, and balancing the deposition step, the clear step, and the etch step against one another at a second balance during the second iteration, where the second iteration occurs after the first iteration, and where the second balance favors the deposition step over the etch step to a greater degree than the first balance, such that an etch profile that forms at an etch front within the feature during the second iteration has a shape that is tapered. In some embodiments, the controller may be configured to cause balancing the deposition step, the clear step, and the etch step against one another at a first balance during a first iteration, and balancing the deposition step, the clear step, and the etch step against one another at a second balance during the second iteration, where the second iteration occurs after the first iteration, and where the second balance favors the etch step over the deposition step to a greater degree than the first balance, such that an etch profile that forms at an etch front within the feature during the second iteration has a shape that is reentrant.

In various embodiments, the controller may be configured to cause generating the plasma in a continuous manner such that the plasma is not extinguished between the deposition step, the clear step, and the etch step. In some embodiments, the controller may be configured to cause the clear step immediately after either the deposition step or the etch step.

These and other aspects are described further below with reference to the drawings.

### BRIEF DESCRIPTION OF THE DRAWINGS

FIGS. 1A-1C depict a partially etched feature over the course of a single etching iteration in a cyclic process involving a deposition step (FIG. 1A), a clear step (FIG. 1B), and an etch step (FIG. 1C).

FIG. 2 illustrates an example feature profile that may be achieved using the disclosed techniques.

FIG. 3 shows an apparatus configured for plasma processing according to various embodiments herein.

FIG. 4 depicts a cluster architecture configured for plasma processing according to various embodiments herein.

FIG. 5 shows experimental results illustrating various profile shapes that can be achieved using the techniques disclosed herein.

FIG. 6 presents a flowchart describing a method of etching a feature according to various embodiments herein.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

Semiconductor device manufacturing continues to push the limits with respect to increasing chip density and reducing bit costs. One technique for accomplishing this in the context of 3D NAND has been to increase the number of alternating layers in the mold stack (e.g., with current devices frequently employing 90+ NAND layers). As a result, the depth: width aspect ratio of the features formed in the mold stack has been increasing. This increased aspect ratio presents substantial challenges with regard to forming the features at desired specifications (e.g., an acceptable etch rate, etch profile, degree of bowing, degree of twisting, degree of circularity, degree of uniformity, etc.).

In various embodiments herein, recessed features are formed in a carbon mask layer. After the features are formed in the carbon mask layer, it may be used as a mask to transfer the recessed features down into an underlying material. The underlying material may be dielectric material, for example a 3D NAND mold stack that includes alternating layers of dielectric materials such as silicon oxide and silicon nitride, or silicon oxide and polysilicon.

Carbon masks have shown promise, particularly in the context of a high aspect ratio etch where the features have a depth: width aspect ratio of about 50:1 or greater. However, carbon masks have presented certain difficulties with respect to profile challenges such as bowing, bottom critical dimension (CD) control, and local CD uniformity, as well as hole circularity. Poor profile and local CD uniformity when etching the carbon mask can have a big impact on subsequent memory hole formation, and can eventually lead to electrical failure at the memory string level, compromising final device performance.

Typically, a process called reactive ion etching is used to etch the features into the carbon mask. A second mask layer, often silicon-based (e.g., SiON, SiO, SiN, SiOC, SiB, etc.) is provided above the carbon mask. The second mask layer is patterned to define where the features are to be etched in the carbon mask (and the underlying material). The substrate is exposed to an oxygen-based plasma to transfer the features from the second mask layer into the carbon mask. During this etch process, profile bowing commonly occurs, usually due to ion angular distribution and ion scattering behavior arising from changes to the mask shape (e.g., faceted, clogged, etc.). A sulfur-based passivation gas may be added into the oxygen-based plasma to provide sidewall protection. However, excessive passivation gas can lead to non-circular hole shape and a slow etch rate.

Another challenge of high aspect ratio memory hole etch is to maintain good local CD uniformity throughout the entire process. In high aspect ratio etch, local CD uniformity tends to be poor due to mask sputtering and re-deposition behavior. For example, material from the silicon-based second mask layer may sputter and re-deposit near the top of the feature, causing the feature to become clogged, non-circular, or otherwise have a non-desired etch profile. These issues are not desirable.

In the embodiments herein, a new approach is used for etching the carbon mask. The new approach provides a cyclic etching method involving: (1) a deposition step, (2) a clear step, and (3) an etch step. These steps may be performed in any order, and may be cycled with one another until the features reach their final depth in the carbon mask. The steps may be cycled in a continuous manner to maximize throughput. Alternatively, the steps can be performed in a non-continuous manner. The features are actively etched during all three steps. In other words, the features continue to deepen even during the deposition and clear steps.

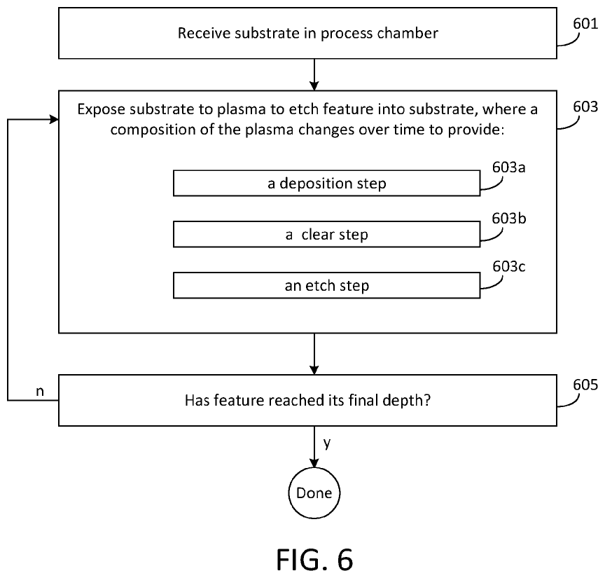

FIG. 6 provides a flowchart describing a method of etching a feature in a substrate according to various embodiments herein. The method begins with operation 601, where a substrate is received in a process chamber. The substrate includes a carbon layer and a mask layer positioned over the carbon layer. The mask layer is patterned to define where the feature will be etched in the carbon layer. At operation 603, the substrate is exposed to plasma. During operation 603, a composition of the plasma is changed over time to provide a deposition step 603a, a clear step 603b, and/or an etch step 603c. Each of these steps is further described below. At operation 605, it is determined whether the feature has reached its final depth. Such a determination may be made based on one or more factors including, but not limited to, processing time, reactant flow rates, plasma conditions, and/or metrology. The plasma may or may not be extinguished during operation 605. If the feature has reached its final depth at operation 605, the method is complete. If the feature has not yet reached its final depth at operation 605, the method cycles back to operation 603, where the substrate continues to be exposed to the plasma (or is exposed to the plasma another time). Operation 603 (including the deposition step 603a, the clear step 603b, and the etch step 603c) is repeated until the feature reaches its final depth. Notably, as operation 603 is repeated, the balance between the deposition step 603a, the clear step 603b, and the etch step 603c can be controlled and varied to produce a desired feature shape.

The new approach is similar to the Bosch Process, which is a cyclic etching process designed for forming high aspect ratio features in silicon. The process has been adapted and modified for etching carbon, rather than silicon. Previously, such a process had not been applied to etching carbon-based materials.

One advantage of the disclosed techniques is that the etch profile can be very carefully controlled to achieve desired CDs along the entire depth of the feature. This has the potential to enable any profile shape within the etched carbon mask. This high degree of CD/profile control can be achieved by controlling the balance between the different steps (e.g., deposition vs. clear vs. etch) during each iteration. The resulting profile in the etched carbon can be vertical, slanted, curved, tapered, reentrant, bowed, or a combination thereof. The desired profile shape may depend on the particular application. The disclosed techniques provide a number of additional benefits, as well. These include high throughput, good hole shape performance, and low cost compared to other expensive passivation schemes.

A related advantage of the disclosed techniques is that the development process for optimizing a memory hole etch (or other application) can be substantially shortened, resulting in faster process development cycles. With conventional etching techniques such as Reactive Ion Etching, there are significant tradeoffs with respect to optimizing different aspects of the etching process and the resulting features. Such tradeoffs include improved or degraded performance with respect to bottom hole shape, local CD uniformity, unopen performance, etc. Frequently, a technique that improves one of these properties will degrade another of these properties. As such, it is very difficult to design a process that achieves adequate performance with respect to all of these properties. In recent years, there have been many optimization requirements with respect to memory hole etch to achieve the best performance. Because of the difficulties stated above, any profile tuning in the context of a Reactive Ion Etch involves substantial effort over a long period of time in order to address the various tradeoffs. By contrast, the techniques disclosed herein provide a great deal of profile flexibility, enabled by tuning the deposition, clear, and etch steps during each iteration to control the CD and related local profile shape at each etch depth. This is expected to substantially shorten the process development cycle.

As mentioned above, the disclosed etching technique involves three steps including a deposition step, a clear step, and an etch step. All three steps involve exposure of the substrate to an oxygen-based plasma, with particular additional chemistries provided during each step. The steps are cycled with one another until the features are fully etched in the carbon mask.

The substrate that is etched includes at least a carbon layer, which may later act as a mask layer when transferring the features into underlying material such as dielectric material. The carbon layer may be amorphous, and may be formed through a method such as chemical vapor deposition (CVD), physical vapor deposition (PVD), etc. The features are etched into the carbon layer. In many embodiments, the substrate further includes a mask layer above the carbon layer, which defines where the features are formed in the carbon layer. This mask layer may be a silicon-based material as mentioned above. In these or other embodiments, the substrate may further include underlying material positioned below the carbon layer. The underlying material may include dielectric material, for example a mold stack for forming a 3D NAND device.

While the embodiments herein are presented in the context of memory applications such as 3D NAND, it is understood that the embodiments are not so limited. Generally, the techniques herein can be applied to any embodiment where features are etched in carbon, without regard to whether the carbon is later used as a mask layer, and without regard to the other materials that may be present on the substrate. Other particular applications where the disclosed techniques may be used include, but are not limited to, DRAM and logic applications. In some such applications, the process conditions described below may be modified as appropriate for the particular application. For instance, such applications may utilize a lower power regime and/or shorter plasma exposure durations than those listed below.

During the deposition step, a boron-based film (e.g., boron oxide) is deposited within the feature. The boron-based film is deposited in a conformal manner and protects the sidewalls from becoming over-etched. Boron-based passivation film has a low sticking coefficient and does not form aggregation easily. Ion bombardment causes the boron-based film to migrate from the top of the feature (where deposition is initiated), down the sidewalls of the feature. Boron oxide shows good etch resistance to oxygen-based plasma, making it an excellent material for protecting the sidewalls of the feature from becoming over-etched. This protection also enables the use of relatively aggressive plasma conditions that provide a very high etch rate (e.g., during all steps) without compromising the feature profile. The feature is also actively etched during the deposition step. In fact, etching can occur at a very high rate during the deposition step, with an etch rate often between about 100 nm/min and about 1000 nm/min. Aggressive plasma conditions (e.g., relatively high TCP power and high bias voltage, as noted below) contribute to the high etch rate. Etching during the deposition step is substantially vertical (rather than isotropic/lateral) due to the formation of the boron-based film that acts to protect the sidewalls. Deposition of the boron-based film, together with the clear and etch steps, results in a high degree of controllability with respect to the shape of the etch profile.

To accomplish the deposition step, the substrate is exposed to a relatively aggressive plasma. The plasma is an oxygen-based plasma generated from a plasma generation gas that includes at least an oxygen source (e.g., O₂, H₂O, CO₂, CO, COS, O₃, etc.) and a boron source (e.g., BCl₃, B₂H₆, B(CH₃)₃, etc.). The plasma generation gas may further include an optional passivation chemistry source (e.g., COS, SO₂, N₂, CO₂, etc.) that may act to further passivate the feature sidewalls in combination with the boron source. The oxygen source may be provided between a minimum rate of about 100 sccm and a maximum rate of about 2000 sccm. The boron source may be provided between a minimum rate of about 5 sccm and a maximum rate of about 100 sccm. The passivation chemistry source, if present, may be provided between a minimum rate of about 25 sccm and a maximum rate of about 500 sccm. In various embodiments, the passivation chemistry source may be provided at a higher or lower flow rate than the boron source. Typically, the flow of the oxygen source is substantially higher than the combined flow of the boron source and the passivation chemistry source. The plasma may also include one or more inert gas/carrier gas such as Ar, He, Ne, etc. The plasma is a transformer coupled plasma (TCP) generated at a high TCP power and high bias voltage. For instance, the plasma may be generated at a minimum source TCP power of about 500 W. In these or other embodiments, the plasma may be generated at a maximum source TCP power of about 7500 W. The source TCP power may be provided at one or more frequencies such as 13 MHz, 2 MHz, or a combination thereof. In addition, the substrate is heavily biased during the deposition step. For example, the substrate may be biased (e.g., at a frequency between about 13 MHz and about 400 kHz) between a minimum bias power of about 50 W and a maximum bias power of about 8000 W. The plasma may be generated with a particular duty cycle during the deposition stage, for example between a minimum duty cycle of about 5% and a maximum duty cycle of about 100%. These plasma generation conditions represent those appropriate for processing a single 300 mm diameter semiconductor substrate, and may be scaled appropriately for additional substrates or substrates of other sizes.

A number of other process conditions may be controlled during the deposition step. For example, a pressure in the process chamber may be between a minimum of about 10 mT and a maximum of about 50 mT. A temperature of the substrate may be controlled, for example by controlling the temperature of a substrate support and/or related hardware. In various embodiments, the substrate support temperature may be controlled between a minimum temperature of about −40° C. and a maximum temperature of about 100° C.

The duration of the deposition step can be controlled during each iteration, and may vary between different iterations. Generally, the duration of the deposition step may be between a minimum duration of about 3 seconds and a maximum duration of about 30 seconds. As discussed further below, the ratios of the durations of the various steps (deposition, clear, and etching) during each iteration strongly affects the shape of the etch profile that forms.

During the clear step, excessive polymer buildup is removed from the etch front (e.g., the bottom of the feature). Further, any etch byproducts that are clogging or beginning to clog the feature (e.g., on the sidewalls of the mask) can be removed. Such etch byproducts commonly include SiO-based materials that originate from the mask layer above the carbon layer. These byproducts are problematic because they contribute to local depth and CD non-uniformity across the substrate. The feature is also actively etched during the clear step. For example, an etch rate during the clear step may be between about 50 nm/min and about 1000 nm/min.

To accomplish the clear step, the substrate is exposed to a relatively aggressive plasma generated from a combination of an oxygen source, a halogen source, and an optional passivation chemistry source. In many cases the halogen source is a fluorine source (e.g., CₓF_{y} (e.g., CF₄, C₂F₆, C₄F₆, C₄F₈, etc.), NF₃, SF₆, CHₓF_{y} (e.g., CHF₃, CH₂F₂, CH₃F), SiF₄, etc.) or a chlorine source (e.g., Cl₂, HCl, etc.). The passivation chemistry source may include one or more passivation chemistry sources listed above. The oxygen source may include one or more oxygen sources listed above. The oxygen source may be provided between a minimum rate of about 100 sccm and a maximum rate of about 2000 sccm. The halogen source may be provided between a minimum rate of about 3 sccm and a maximum rate of about 100 sccm. The passivation chemistry source, if any, may be provided between a minimum rate of about 25 sccm and a maximum rate of about 500 sccm. In various embodiments, the passivation chemistry source may be provided at a higher or lower flow rate than the halogen source. Typically, the flow of the oxygen source is substantially higher than the combined flow of the halogen source and the passivation chemistry source. The plasma may also include one or more inert gas/carrier gas such as Ar, He, Ne, etc. The plasma is a transformer coupled plasma (TCP) generated at a high TCP power and high bias voltage. For instance, the plasma may be generated at a minimum source TCP power of about 500 W. In these or other embodiments, the plasma may be generated at a maximum source TCP power of about 7500 W. The source TCP power may be provided at one or more frequencies such as 13 MHz, 2 MHz, or a combination thereof. In addition, the substrate is heavily biased during the clear step. For example, the substrate may be biased (e.g., at a frequency between about 13 MHz and about 400 kHz) between a minimum bias power of about 50 W and a maximum bias power of about 8000 W. The plasma may be generated with a particular duty cycle during the clear step, for example between a minimum duty cycle of about 5% and a maximum duty cycle of about 100%. These plasma generation conditions represent those appropriate for processing a single 300 mm diameter semiconductor substrate, and may be scaled appropriately for additional substrates or substrates of other sizes.

A number of other process conditions may be controlled during the clear step. For example, a pressure in the process chamber may be between a minimum of about 10 mT and a maximum of about 50 mT. A temperature of the substrate may be controlled, for example by controlling the temperature of a substrate support and/or related hardware. In various embodiments, the substrate support temperature may be controlled between a minimum temperature of about −40° C. and a maximum temperature of about 100° C.

The duration of the clear step can be controlled during each iteration, and may vary between different iterations. Generally, the duration of the clear step may be between a minimum duration of about 1 second and a maximum duration of about 15 seconds. As discussed further below, the ratios of the durations of the various steps (deposition, clear, and etching) during each iteration strongly affects the shape of the etch profile that forms.

During the etch step, the features are etched isotropically (e.g., etched both vertically and laterally). Unlike the traditional Bosch process performed to etch silicon, the disclosed etching process utilizes both radicals and ions to perform the etch step. For high density carbon, the chemical etch rate is usually quite slow (e.g., <200 nm/min at an aspect ratio of about 10:1) compared to the ion-assisted etch rate (e.g., >500 nm/min at an aspect ratio of about 10:1). Due to the strong passivation at the pre-etched sidewall surface originating from the deposition step, ion scattering happens at the pre-etched sidewall to create a bowed, vertical, or tapered profile at the etch front. The etch profile that forms depends on the balance between the etchant and polymer formation at the etch front, which is largely a result of the balance between the deposition, clear, and etch steps, including the flows provided during each step and the duration of each step.

To accomplish the etch step, the substrate is exposed to a relatively aggressive plasma generated from an oxygen source and an optional passivation chemistry source. The passivation chemistry source may include one or more passivation chemistry sources listed above. The oxygen source may include one or more oxygen sources listed above. The oxygen source may be provided between a minimum rate of about 100 sccm and a maximum rate of about 2000 sccm. The passivation chemistry source, if any, may be provided between a minimum rate of about 25 sccm and a maximum rate of about 500 sccm. Typically, the flow of the oxygen source is substantially higher than the flow of the passivation chemistry source. The plasma may also include one or more inert gas/carrier gas such as Ar, He, Ne, etc. The plasma is a transformer coupled plasma (TCP) generated at a high TCP power and high bias voltage. For instance, the plasma may be generated at a minimum source TCP power of about 500 W. In these or other embodiments, the plasma may be generated at a maximum source TCP power of about 7500 W. The source TCP power may be provided at one or more frequencies such as 13 MHz, 2 MHz, or a combination thereof. In addition, the substrate is heavily biased during the etch step. For example, the substrate may be biased (e.g., at a frequency between about 13 MHz and about 400 kHz) between a minimum bias power of about 50 W and a maximum bias power of about 8000 W. The plasma may be generated with a particular duty cycle during the etch step, for example between a minimum duty cycle of about 5% and a maximum duty cycle of about 100%. These plasma generation conditions represent those appropriate for processing a single 300 mm diameter semiconductor substrate, and may be scaled appropriately for additional substrates or substrates of other sizes.

A number of other process conditions may be controlled during the etch step. For example, a pressure in the process chamber may be between a minimum of about 10 mT and a maximum of about 50 mT. A temperature of the substrate may be controlled, for example by controlling the temperature of a substrate support and/or related hardware. In various embodiments, the substrate support temperature may be controlled between a minimum temperature of about −40° C. and a maximum temperature of about 100° C.

The duration of the etch step can be controlled during each iteration, and may vary between different iterations. Generally, the duration of the etch step may be between a minimum duration of about 5 seconds and a maximum duration of about 50 seconds.

In various embodiments, the plasma generation gas used to form the plasma may have relatively less polymerizing chemistry (e.g., compared to the deposition and/or clear step) to reduce formation of polymer at the etch front. This strategy may promote better circularity of the etched features.

Together, the deposition, clear, and etch steps from a single iteration may have a combined duration between about 1-100 seconds. The total number of iterations may be between about 10-10,000. In many cases, these steps are performed continuously, without extinguishing the plasma, to maximize throughput. In order to switch between steps, the chemistry provided to the reaction chamber is controlled as described above. Fast switching hardware may be provided to enable rapid switching between different chemistries. In some cases, the hardware (e.g., valves and related plumbing) may be similar to that commonly used for atomic layer deposition (ALD), which often involves fast switching times for different chemistries. This hardware may enable improved phase separation and improved etch performance.

In addition, one or more other processing conditions may be changed between the steps, including but not limited to pressure, substrate support temperature, TCP plasma source power, TCP plasma frequency, bias power, bias frequency, duty cycle, etc.

Generally speaking, the shape of the etch front can be controlled to produce a desired etch profile by balancing the deposition, clear, and etch steps. For instance, a first iteration may provide a particular degree of deposition, clearing, and etching. A second iteration that favors deposition over clearing and/or etching can produce a local etch profile that is tapered at that depth (as used herein, a local profile that is tapered is wider at a top portion and narrower at a bottom portion). By contrast, if the second iteration favors clearing and/or etching over deposition, the local etch profile that forms at this depth may be reentrant. As used herein, a local profile that is reentrant is narrower at a top portion and wider at a bottom portion. Similarly, if the second iteration provides a balanced amount of deposition, clearing, and etching (e.g., not substantially favoring any particular step), the local profile that forms at the etch front is substantially vertical. The deposition, clear, and etch steps are repeated, with the balance between these steps during each iteration controlling the shape of the etch profile that forms.

The disclosed techniques provide a high degree of profile control flexibility, including the ability to achieve a target CD at a desired depth. These factors substantially improve the profile and performance control for the subsequent memory hole etch or other etch process for which the carbon is used as a mask.

The balance between the deposition, clear, and etch steps can be controlled in a number of ways. For instance, the duration of each step can be controlled, and the ratio of these durations can be controlled. Alternatively or in addition, the flow rates provided during each step can be controlled, as can the ratio of these flow rates between different steps. Alternatively or in addition, the plasma conditions and/or other processing conditions provided during each step can be controlled, as can the ratio of such conditions between different steps. Example conditions that may be controlled to influence the balance between each step during each iteration include, but are not limited to, duration, plasma power, duty cycle, bias voltage, chemistry, pressure, temperature, etc. As described throughout the application, the balance between the deposition, clear, and etch steps during each iteration controls the shape of the etch profile that forms. In various embodiments, the balance between these steps is varied between different iterations (e.g., by varying one or more processing condition between different iterations, as described herein) to achieve a desired etch profile. Any one or more of the processing conditions described herein may be varied between different iterations to achieve a desired balance between the deposition, clear, and etch steps for each iteration. The ratio of such processing conditions between different iterations may be controlled. In other words, the various processing conditions may be controlled, varied, and balanced against one another (1) within each step, (2) between the steps in a given iteration, and/or (3) between different iterations.

While the deposition, clear, and etch steps together form a single iteration, it is understood that one or more of these steps may be omitted or repeated within a single iteration. Such omissions and repetitions can vary over the course of the various iterations of the etching process to achieve a desired etch profile. For example, a first iteration could involve a deposition step, a clear step, and an etch step; a second iteration could involve a deposition step and an etch step; a third iteration could involve a deposition step and a clear step; a fourth iteration could involve a clear step and an etch step, etc. These can be mixed and matched as desired for a particular application and desired etch profile. Similarly, while the deposition step, clear step, and etch step are usually described in that order, it is understood that these steps may be done in any order. For example, the clear step can be performed after the deposition step and/or after the etch step to remove polymer buildup at different times. Further, the order of these steps may vary between different iterations. In one example, a first iteration involves a deposition step, followed by a clear step, followed by an etch step, and a second iteration involves a deposition step, followed by an etch step, followed by a clear step. Many variations are possible.

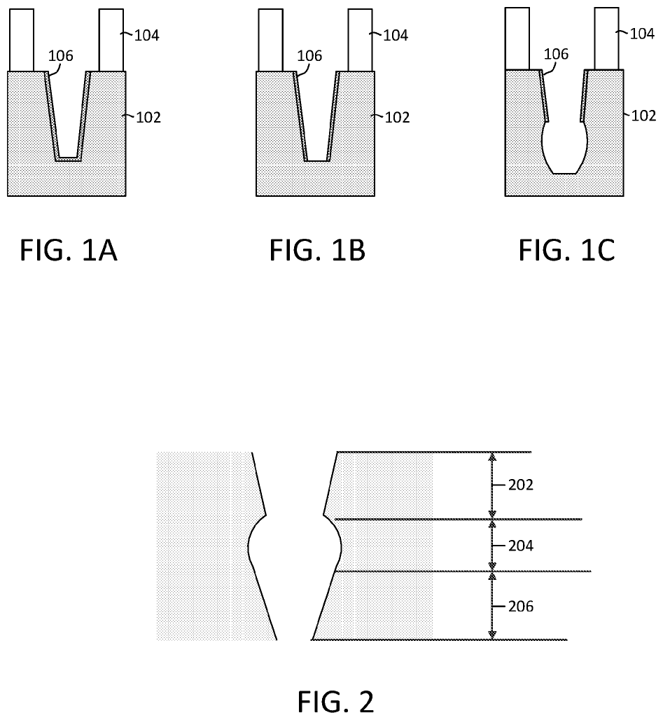

FIGS. 1A-1C together illustrate a partially etched feature in a substrate over the course of a single etching iteration according to various embodiments herein. The substrate includes a carbon layer 102 and a mask layer 104. The carbon layer 102 may be subsequently used as a mask layer for etching an underlying layer (e.g., to form memory holes in dielectric materials in various embodiments). The mask layer 104 is patterned to include a series of openings that define where the features are etched in the carbon layer 102. The mask layer 104 is a silicon-based mask material in various embodiments, although any appropriate mask material may be used.

FIG. 1A shows the substrate after a deposition step. As mentioned above, during the deposition step, the feature is actively etched into the carbon layer 102, and a boron-based film 106 is simultaneously formed on the sidewalls and bottom of the partially etched feature. FIG. 1B shows the substrate after a clear step. During the clear step, the feature is actively etched into the carbon layer 102, and the boron-based film 106 is removed from the bottom of the feature. This acts to clear the etch front, allowing for more substantial etching, while maintaining a high degree of protection on the feature sidewalls where the boron-based film 106 is present. Although FIG. 1B does not show a substantial amount of additional etch depth compared to FIG. 1A, it is understood that etching is occurring during this step. FIG. 1C shows the substrate after an etch step. During the etch step, the feature is actively etched into the carbon layer 102. As shown in FIG. 1C, during the etch step the bottom of the feature is etched an isotropic manner, meaning that etching occurs both vertically and laterally. Because the boron-based film 106 does not form during the etch step, substantial lateral etching can be achieved at the etch front, if desired, during this step.

Each of the steps provides distinct advantages that combine to produce highly customizable and high quality features. For instance, the deposition step promotes a low degree of bowing, the clear step promotes a high degree of local CD uniformity, the etch step (in combination with the other steps) promotes a tunable profile and a high degree of feature circularity, and all three of these steps promote a high etch rate.

FIG. 2 presents an example feature profile that can be achieved using the disclosed

techniques. This feature profile represents the profile achieved during a single iteration of the etching method described herein, e.g., a deposition step, a clear step, and an etch step. Although many different profile shapes can be formed, the shape shown in FIG. 2 is particularly advantageous in the context of etching a carbon layer that will be used as a mask layer for etching memory holes or other recessed features in dielectric material positioned under the carbon layer.

The feature profile includes an upper portion 202, a middle portion 204, and a lower portion 206. In various embodiments, the upper portion 202 is substantially formed during the deposition step, and the middle portion 204 and the lower portion 206 are substantially formed during the etch step. The clear step can also contribute to the shape of each of these portions. In this example, the upper portion 202 includes a tapered profile, the middle portion 204 includes a bowed/reentrant profile, and the lower portion 206 includes a tapered profile. In a similar example, the upper portion 202 includes a substantially vertical profile. Each of these portions contributes to the etch profile and the related CD achieved at each depth.

### APPARATUS

The methods described herein can be performed by any suitable apparatus. A suitable apparatus includes at least a process chamber, a plasma generator configured to generate plasma within the process chamber, and a controller configured to cause one or more methods described herein.

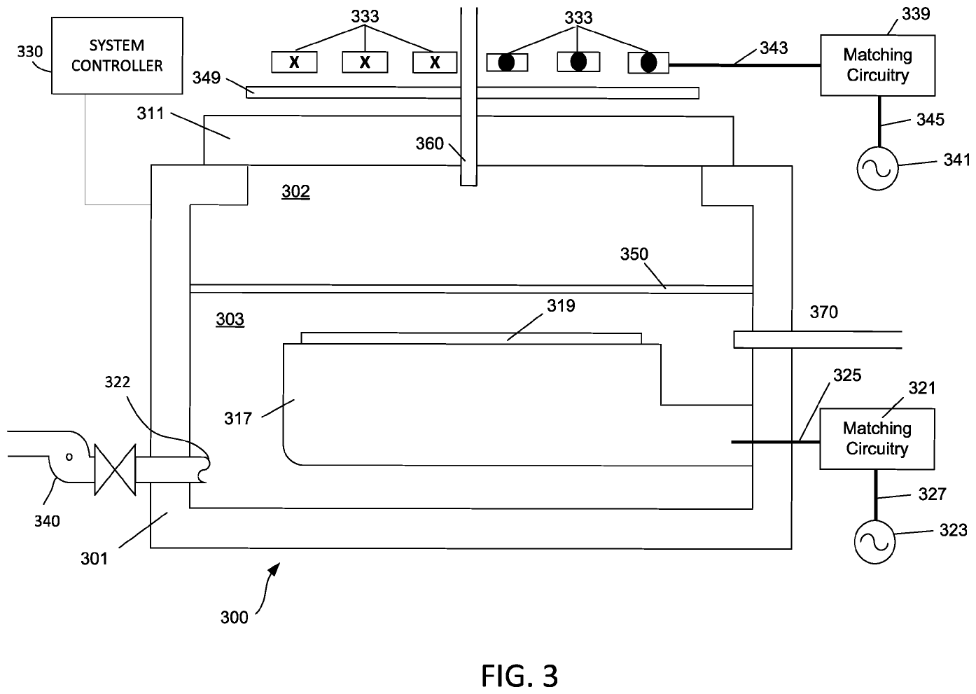

FIG. 3 schematically shows a cross-sectional view of an inductively coupled plasma etching apparatus 300 in accordance with certain embodiments herein. A Kiyo™ reactor, produced by Lam Research Corp. of Fremont, CA, is an example of a suitable reactor that may be used to implement the techniques described herein. The inductively coupled plasma etching apparatus 300 includes an overall etching chamber structurally defined by walls of chamber 301 and a window 311. The walls of chamber 301 may be fabricated from stainless steel or aluminum. The window 311 may be fabricated from quartz or other dielectric material. An optional plasma grid 350 divides the overall etching chamber into an upper sub-chamber 302 and a lower sub-chamber 303. The plasma grid 350 may include a single grid or multiple individual grids. In many embodiments, plasma grid 350 may be removed, thereby utilizing a chamber space made of sub-chambers 302 and 303.

A chuck 317 (also referred to as a substrate support) is positioned within the lower sub-chamber 303 near the bottom inner surface. The chuck 317 is configured to receive and hold a wafer 319 (e.g., a semiconductor wafer) upon which the etching process is performed. The chuck 317 can be an electrostatic chuck for supporting the wafer 319 when present. In some embodiments, an edge ring (not shown) surrounds chuck 317, and has an upper surface that is approximately planar with a top surface of a wafer 319, when present over chuck 317. The chuck 317 also includes electrostatic electrodes for chucking and dechucking the wafer. A filter and DC clamp power supply (not shown) may be provided for this purpose. Other control systems for lifting the wafer 319 off the chuck 317 can also be provided. The chuck 317 can be electrically charged using an RF power supply 323. The RF power supply 323 is connected to matching circuitry 321 through a connection 327. The matching circuitry 321 is connected to the chuck 317 through a connection 325. In this manner, the RF power supply 323 is connected to the chuck 317.

A coil 333 is positioned above window 311. The coil 333 is fabricated from an electrically conductive material and includes at least one complete turn. The coil 333 shown in FIG. 3 includes three turns. The cross-sections of coil 333 are shown with symbols, and coils having an “X” extend rotationally into the page, while coils having a “●” extend rotationally out of the page. An RF power supply 341 is configured to supply RF power to the coil 333. In general, the RF power supply 341 is connected to matching circuitry 339 through a connection 345. The matching circuitry 339 is connected to the coil 333 through a connection 343. In this manner, the RF power supply 341 is connected to the coil 333. An optional Faraday shield 349 is positioned between the coil 333 and the window 311. The Faraday shield 349 is maintained in a spaced apart relationship relative to the coil 333. The Faraday shield 349 is disposed immediately above the window 311. The coil 333, the Faraday shield 349, and the window 311 are each configured to be substantially parallel to one another. The Faraday shield may prevent metal or other species from depositing on the dielectric window of the plasma chamber.

Process gases may be supplied through a main injection port 360 (also referred to as a main inlet) positioned in the upper chamber and/or through a side injection port 370, sometimes referred to as an STG or a side inlet. A vacuum pump, e.g., a one or two stage mechanical dry pump and/or turbomolecular pump 340, may be used to draw process gases out of the process chamber and to maintain a pressure within the plasma etching apparatus 300 by using a closed-loop-controlled flow restriction device, such as a throttle valve (not shown) or a pendulum valve (not shown), during operational plasma processing.

During operation of the apparatus, one or more reactant gases may be supplied through injection ports 360 and/or 370. In certain embodiments, gas may be supplied only through the main injection port 360, or only through the side injection port 370. In some cases, the injection ports may be replaced by showerheads. The Faraday shield 349 and/or optional plasma grid 350 may include internal channels and holes that allow delivery of process gases to the chamber. Either or both of Faraday shield 349 and optional plasma grid 350 may serve as a showerhead for delivery of process gases.

Radio frequency power is supplied from the RF power supply 341 to the coil 333 to cause an RF current to flow through the coil 333. The RF current flowing through the coil 333 generates an electromagnetic field about the coil 333. The electromagnetic field generates an inductive current within the upper sub-chamber 302. The physical and chemical interactions of various generated ions and radicals with the wafer 319 selectively etch features of the wafer.

If the plasma grid 350 is used such that there is both an upper sub-chamber 302 and a lower sub-chamber 303, the inductive current acts on the gas present in the upper sub-chamber 302 to generate an electron-ion plasma in the upper sub-chamber 302. The optional plasma grid 350, if present, may act to limit the number of hot electrons in the lower sub-chamber 303. In some embodiments, the apparatus is designed and operated such that the plasma present in the lower sub-chamber 303 is an ion-ion plasma. In other embodiments, the apparatus may be designed and operated such that the plasma present in the lower sub-chamber 303 is an electron-ion plasma. Internal plasma grids and ion-ion plasma are further discussed in U.S. patent application Ser. No. 14/082,009, filed Nov. 15, 2013, and titled “INTERNAL PLASMA GRID FOR SEMICONDUCTOR FABRICATION,” and in U.S. Pat. No. 9,245,761, each of which is herein incorporated by reference in its entirety.

Volatile etching byproducts may be removed from the lower sub-chamber 303 through port 322 (also referred to as an outlet). The chuck 317 disclosed herein may operate at elevated temperatures ranging between about 30° C. and about 250° C. In some cases, the chuck 317 may also operate at lower temperatures, for example when the chuck 317 is actively chilled. In such cases the chuck 317 may operate at substantially lower temperatures, as desired. The temperature will depend on the etching process operation and specific recipe. In some embodiments, the chamber 301 may operate at pressures in the range of between about 1 mTorr and about 95 mTorr. In certain embodiments, the pressure may be higher.

Chamber 301 may be coupled to facilities (not shown) when installed in a clean room or a fabrication facility. Facilities include plumbing that provide processing gases, vacuum, temperature control, and environmental particle control. These facilities are coupled to chamber 301, when installed in the target fabrication facility. Additionally, chamber 301 may be coupled to a transfer chamber that allows robotics to transfer semiconductor wafers into and out of chamber 301 using typical automation.

In some embodiments, a system controller 330 (which may include one or more physical or logical controllers) controls some or all of the operations of an etching chamber. The system controller 330 may include one or more memory devices and one or more processors. The processor may include a central processing unit (CPU) or computer, analog and/or digital input/output connections, stepper motor controller boards, and other like components. Instructions for implementing appropriate control operations are executed on the processor. These instructions may be stored on the memory devices associated with the system controller 330 or they may be provided over a network. In certain embodiments, the system controller 330 executes system control software.

In some cases, the system controller 330 controls gas concentration, wafer movement, and/or the power supplied to the coils 333 and/or chuck 317. The system controller 330 may control the gas concentration by, for example, opening and closing relevant valves to produce one or more inlet gas stream that provide the necessary reactant(s) at the proper concentration(s). In various embodiments herein, the system controller 330 controls switching between the deposition step, the clear step, and the etch step by causing appropriate chemistry to be provided to the process chamber (e.g., through appropriate valving, plumbing, etc.) at the beginning of each step. The wafer movement may be controlled by, for example, directing a wafer positioning system to move as desired. The power supplied to the coils 333 and/or chuck 317 may be controlled to provide particular RF power levels. Similarly, if the optional plasma grid 350 is used, any RF power applied to the grid may be adjusted by the system controller 330.

The system controller 330 may control these and other aspects based on sensor output (e.g., when power, potential, pressure, etc. reach a certain threshold), the timing of an operation (e.g., opening valves at certain times in a process), or based on received instructions from the user. An example controller is further discussed below.

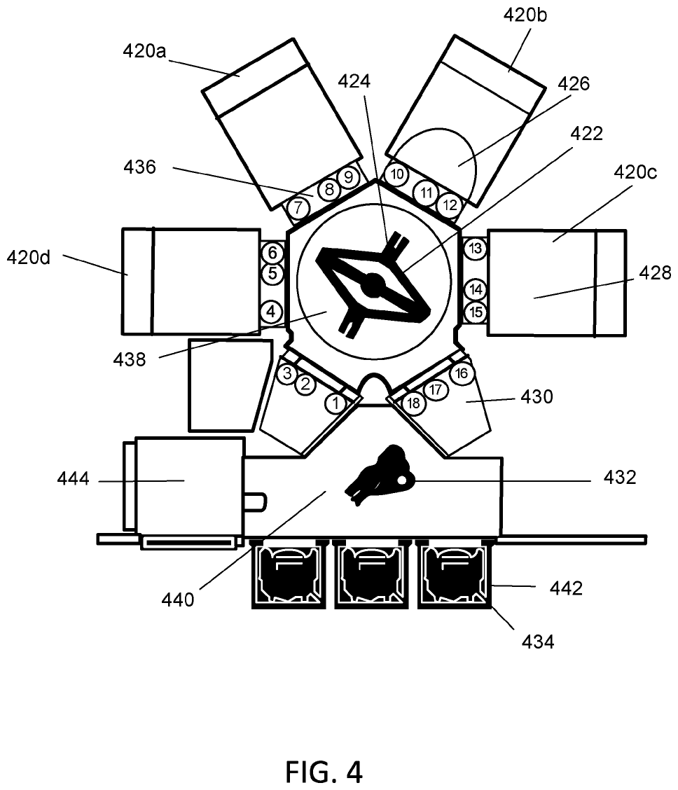

FIG. 4 depicts a semiconductor process cluster architecture with various modules that interface with a vacuum transfer module 438 (VTM). The arrangement of transfer modules to “transfer” wafers among multiple storage facilities and processing modules may be referred to as a “cluster tool architecture” system. Airlock 430, also known as a loadlock or transfer module, is shown in VTM 438 with four processing modules 420a-420d, which may be individually optimized to perform various fabrication processes. By way of example, processing modules 420a-420d may be implemented to perform substrate etching, deposition, ion implantation, wafer cleaning, sputtering, and/or other semiconductor processes. One or more of the substrate etching processing modules (any of 420a-420d) may be implemented as disclosed herein. Airlock 430 and process module 420 may be referred to as “stations.” Each station has a facet 436 that interfaces the station to VTM 438. Inside each facet, sensors 1-18 are used to detect the passing of wafer 426 when moved between respective stations.

Robot 422 transfers wafer 426 between stations. In one embodiment, robot 422 has one arm, and in another embodiment, robot 422 has two arms, where each arm has an end effector 424 to pick wafers such as wafer 426 for transport. Front-end robot 432, in atmospheric transfer module (ATM) 440, is used to transfer wafer 426 from cassette or Front Opening Unified Pod (FOUP) 434 in Load Port Module (LPM) 442 to airlock 430. Module center 428 inside process module 420 is one location for placing wafer 426. Aligner 444 in ATM 440 is used to align wafers.

In an exemplary processing method, a wafer is placed in one of the FOUPs 434 in the LPM 442. Front-end robot 432 transfers the wafer from the FOUP 434 to an aligner 444, which allows the wafer 426 to be properly centered before it is etched or processed. After being aligned, the wafer 426 is moved by the front-end robot 432 into an airlock 430. Because airlock modules have the ability to match the environment between an ATM and a VTM, the wafer 426 is able to move between the two pressure environments without being damaged. From the airlock 430, the wafer 426 is moved by robot 422 through VTM 438 and into one of the process modules 420a-420d. In order to achieve this wafer movement, the robot 422 uses end effectors 424 on each of its arms. Once the wafer 426 has been processed, it is moved by robot 422 from the process modules 420a-420d to an airlock 430. From here, the wafer 426 may be moved by the front-end robot 432 to one of the FOUPs 434 or to the aligner 444.

It should be noted that the computer controlling the wafer movement can be local to the cluster architecture, or can be located external to the cluster architecture in the manufacturing floor, or in a remote location and connected to the cluster architecture via a network.

In some implementations, a controller is part of a system, which may be part of the above-described examples. Such systems can comprise semiconductor processing equipment, including a processing tool or tools, chamber or chambers, a platform or platforms for processing, and/or specific processing components (a wafer pedestal, a gas flow system, etc.). These systems may be integrated with electronics for controlling their operation before, during, and after processing of a semiconductor wafer or substrate. The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor wafer or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dies of a wafer.

The controller, in some implementations, may be a part of or coupled to a computer that is integrated with, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process. In some examples, a remote computer (e.g. a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. These instructions may vary over the course of the different iterations of the deposition step, clear step, and etch step. It should be understood that the parameters may be specific to the type of process to be performed and the type of tool that the controller is configured to interface with or control. Thus as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor wafers.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

### EXPERIMENTAL

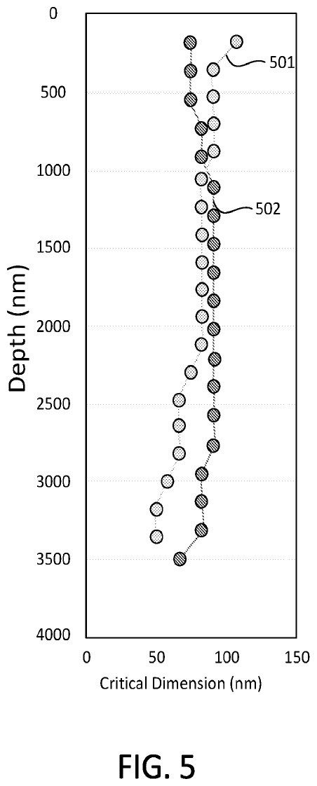

A number of experiments have been conducted to show that the disclosed techniques can be used to create a desired etch profile for features etched in a carbon layer, with a high degree of flexibility with regard to profile shape, and high quality features. The results of one such experiment are shown in FIG. 5. In this experiment, a first substrate and a second substrate were etched using the techniques described herein. FIG. 5 shows the local critical dimension of the features etched in each substrate at various different depth levels. Results related to the first substrate are shown by line 501, and results related to the second substrate are shown by line 502. Each substrate was etched by repeating the deposition, clear, and etch steps described herein. The balance between the different steps was controlled during each iteration for each substrate. Moreover, the balance between the different steps was controlled in different ways for each of the substrates. As a result, the etch profiles that formed were different for the two substrates. As shown in line 501, the first substrate had a profile that included an upper portion that was slightly tapered or vertical, a middle portion that was substantially vertical, and a lower portion that was more tapered than the upper portion. As shown in line 502, the second substrate had a profile that include an upper portion that was vertical or slightly reentrant, a middle portion that was substantially vertical, and a lower portion that was tapered.

While FIG. 5 only shows results related to two substrates, it is understood that the techniques described herein can be used to create essentially any desired etch profile shape, with a tapered, vertical, or reentrant profile at any particular etch depth. This is a substantial improvement over previous carbon etching techniques.

### CONCLUSION

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

What is claimed is:

1. A method of etching a feature into a substrate, the method comprising:
receiving the substrate in a process chamber, the substrate comprising a carbon layer and a mask layer positioned over the carbon layer, wherein the mask layer is patterned to define where the feature will be etched in the carbon layer; and
exposing the substrate to a plasma to etch the feature into the carbon layer of the substrate, wherein a composition of the plasma changes over time to provide at least a deposition step, a clear step, and an etch step, and wherein the deposition step, the clear step, and the etch step are cycled with one another until the feature reaches its final depth.

2. The method of claim 1, wherein during the deposition step, the plasma is generated from a first plasma generation gas comprising a first oxygen source and a boron source, and exposing the substrate to the plasma during the deposition step results in forming boron oxide on sidewalls of the feature.

3. The method of claim 2, wherein during the clear step, the plasma is generated from a second plasma generation gas comprising a second oxygen source and a halogen source, and exposing the substrate to the plasma during the clear step results in removing boron oxide proximate an etch front within the feature.

4. The method of claim 3, wherein during the etch step, the plasma is generated from a third plasma generation gas comprising a third oxygen source, and exposing the substrate to the plasma during the etch step results in etching the feature isotropically at the etch front within the feature.

5. The method of claim 1, wherein the deposition step, the clear step, and the etch step are cycled with one another in iterations, and wherein the deposition step, the clear step, and the etch step are balanced against one another differently in different iterations.

6. The method of claim 5, wherein balancing the deposition step, the clear step, and the etch step against one another differently in different iterations results in an etch profile comprising at least a first portion and a second portion, the first portion and second portion having different profile shapes selected from vertical, reentrant, or tapered.

7. The method of claim 5, wherein during a first iteration, the deposition step, the clear step, and the etch step are balanced against one another at a first balance, and during a second iteration, the deposition step, the clear step, and the etch step are balanced against one another at a second balance, wherein the second iteration occurs after the first iteration, and wherein the second balance favors the deposition step over the etch step to a greater degree than the first balance, such that an etch profile that forms at an etch front within the feature during the second iteration has a shape that is tapered.

8. The method of claim 5, wherein during a first iteration, the deposition step, the clear step, and the etch step are balanced against one another at a first balance, and during a second iteration, the deposition step, the clear step, and the etch step are balanced against one another at a second balance, wherein the second iteration occurs after the first iteration, and wherein the second balance favors the etch step over the deposition step to a greater degree than the first balance, such that an etch profile that forms at an etch front within the feature during the second iteration has a shape that is reentrant.

9. The method of claim 1, wherein the plasma is generated in a continuous manner such that it is not extinguished between the deposition step, the clear step, and the etch step.

10. The method of claim 1, wherein the clear step occurs immediately after either the deposition step or the etch step.

11. An apparatus for etching a feature into a substrate, the apparatus comprising:
a process chamber;
a substrate holder positioned in the process chamber, wherein the substrate holder is configured to support the substrate, the substrate comprising a carbon layer and a mask layer positioned over the carbon layer, wherein the mask layer is patterned to define where the feature will be etched in the carbon layer;
an inlet to the process chamber configured to provide reactants to the process chamber;
an outlet to the process chamber configured to remove materials from the process chamber;
a plasma generator configured to generate plasma in the process chamber; and
a controller configured to cause:
exposing the substrate to a plasma to etch the feature into the carbon layer of the substrate, wherein a composition of the plasma changes over time to provide at least a deposition step, a clear step, and an etch step, and wherein the deposition step, the clear step, and the etch step are cycled with one another until the feature reaches its final depth.

12. The apparatus of claim 11, wherein during the deposition step, the controller is configured to cause generating the plasma from a first plasma generation gas comprising a first oxygen source and a boron source such that exposing the substrate to the plasma during the deposition step results in forming boron oxide on sidewalls of the feature.

13. The apparatus of claim 12, wherein during the clear step, the controller is configured to cause generating the plasma from a second plasma generation gas comprising a second oxygen source and a halogen source such that exposing the substrate to the plasma during the clear step results in removing boron oxide proximate an etch front within the feature.

14. The apparatus of claim 13, wherein during the etch step, the controller is configured to cause generating the plasma from a third plasma generation gas comprising a third oxygen source such that exposing the substrate to the plasma during the etch step results in etching the feature isotropically at the etch front within the feature.

15. The apparatus of claim 11, wherein the controller is configured to cause the deposition step, the clear step, and the etch step to be cycled with one another in iterations, and wherein the controller is configured to cause the deposition step, the clear step, and the etch step to be balanced against one another differently in different iterations.

16. The apparatus of claim 15, wherein the controller is configured to cause balancing the deposition step, the clear step, and the etch step against one another differently in different iterations such that an etch profile comprising at least a first portion and a second portion forms within the feature, the first portion and second portion having different profile shapes selected from vertical, reentrant, or tapered.

17. The apparatus of claim 15, wherein the controller is configured to cause balancing the deposition step, the clear step, and the etch step against one another at a first balance during a first iteration, and balancing the deposition step, the clear step, and the etch step against one another at a second balance during the second iteration, wherein the second iteration occurs after the first iteration, and wherein the second balance favors the deposition step over the etch step to a greater degree than the first balance, such that an etch profile that forms at an etch front within the feature during the second iteration has a shape that is tapered.

18. The apparatus of claim 15, wherein the controller is configured to cause balancing the deposition step, the clear step, and the etch step against one another at a first balance during a first iteration, and balancing the deposition step, the clear step, and the etch step against one another at a second balance during the second iteration, wherein the second iteration occurs after the first iteration, and wherein the second balance favors the etch step over the deposition step to a greater degree than the first balance, such that an etch profile that forms at an etch front within the feature during the second iteration has a shape that is reentrant.

19. The apparatus of claim 11, wherein the controller is configured to cause generating the plasma in a continuous manner such that the plasma is not extinguished between the deposition step, the clear step, and the etch step.

20. The apparatus of claim 11, wherein the controller is configured to cause the clear step immediately after either the deposition step or the etch step.
